(19) United States
(12) Patent Application Publication
(10) Pub. No.: US 2025/0069248 A1
(43) Pub. Date: Feb. 27, 2025

(54) METHOD AND APPARATUS FOR DEPTH ESTIMATE OF BINOCULAR IMAGE, ELECTRONIC DEVICE, AND STORAGE MEDIUM

(71) Applicant: Beijing Zitiao Network Technology Co., Ltd., Beijing (CN)

(72) Inventors: Shuheng WANG, Beijing (CN); Yifeng ZHOU, Beijing (CN); Wenfa LI, Beijing (CN); Chao ZHANG, Beijing (CN); Shaohui JIAO, Beijing (CN)

(21) Appl. No.: 18/812,786

(22) Filed: Aug. 22, 2024

(30) Foreign Application Priority Data
Aug. 23, 2023 (CN) 202311070304.0

(51) Int. Cl. G06T 7/593; G06T 3/40; G06V 10/25

(52) U.S. Cl. CPC G06T 7/593; G06T 3/40; G06V 10/25; G06T 2207/20132

(57) ABSTRACT

A method and an apparatus for depth estimate of a binocular image, wherein the method comprises: obtaining a binocular image captured by a binocular camera, the binocular image including a first image and a second image, wherein the first image includes a first region of interest and the second image includes a second region of interest, and the first region of interest and the second region of interest indicate the same object; obtaining a parallax map between the first image and the second image as a first parallax map and obtaining a parallax map between the first region of interest and the second region of interest as a second parallax map; updating the first parallax map with the second parallax map to obtain the updated first parallax map; generating, based on the updated first parallax map, a depth map corresponding to the binocular image.

### CROSS-REFERENCE TO RELATED APPLICATION(S)

This application claims priority to Chinese Application No. 202311070304.0 filed on Aug. 23, 2023, the disclosure of which is incorporated herein by reference in its entirety.

### FIELD

The present disclosure relates to the image processing technologies, and more specifically, to a method and an apparatus for depth estimate of a binocular image, an electronic device and a storage medium.

### BACKGROUND

In modelling field, it is required to estimate the depth of the binocular image captured by the binocular camera to obtain a depth map and further carry out the modeling on the basis of the depth map. During depth estimate of the binocular image, one image in the binocular image may act as the reference image to generate a depth map of the reference image as the depth map corresponding to the binocular image. At present, the scheme for depth estimate of the binocular image is defective in low accuracy for depth estimate of the key regions in the binocular image.

### SUMMARY

Embodiments of the present disclosure provide a method and an apparatus for depth estimate of a binocular image, an electronic device and a storage medium, to improve the accuracy for depth estimate of key regions in the binocular image.

In a first aspect, the present disclosure provides a method for depth estimate of a binocular image, comprising:
obtaining a binocular image captured by a binocular camera, the binocular image including a first image and a second image, wherein the first image includes a first region of interest and the second image includes a second region of interest, and the first region of interest and the second region of interest indicate the same object;
obtaining a parallax map between the first image and the second image as a first parallax map and obtaining a parallax map between the first region of interest and the second region of interest as a second parallax map;
updating the first parallax map with the second parallax map to obtain the updated first parallax map;
generating, based on the updated first parallax map, a depth map corresponding to the binocular image.

In a second aspect, embodiments of the present disclosure provide an apparatus for depth estimate of a binocular image, comprising:
a first obtaining unit for obtaining a binocular image captured by a binocular camera, the binocular image including a first image and a second image, wherein the first image includes a first region of interest and the second image includes a second region of interest, and the first region of interest and the second region of interest indicate the same object;
a second obtaining unit for obtaining a parallax map between the first image and the second image as a first parallax map and obtaining a parallax map between the first region of interest and the second region of interest as a second parallax map;
a parallax updating unit for updating the first parallax map with the second parallax map to obtain the updated first parallax map;
an image generating unit for generating, based on the updated first parallax map, a depth map corresponding to the binocular image.

In a third aspect, embodiments of the present disclosure provide an electronic device, comprising: a processor; and a memory configured to store computer-executable instructions, the computer-executable instructions, when executed, causing the processor to implement steps of the method according to the above first aspect.

In a fourth aspect, embodiments of the present disclosure provide a computer readable storage medium, wherein the computer readable stored medium stores computer-executable instructions, the computer-executable instructions, when executed by a processor, implementing steps of the method according to the above first aspect.

In one or more embodiments of the present disclosure, a binocular image captured by a binocular camera is firstly obtained, the binocular image including a first image and a second image; the first image includes a first region of interest and the second image includes a second region of interest; and the first region of interest and the second region of interest indicate the same object. Then, a parallax map between the first image and the second image is obtained as a first parallax map and a parallax map between the first region of interest and the second region of interest is obtained as a second parallax map; and the first parallax map is updated with the second parallax map to obtain the updated first parallax map. In the end, a depth map corresponding to the binocular image is generated based on the updated first parallax map. Accordingly, by this embodiment, a parallax map between the first region of interest and the second region of interest may serve as a second parallax map; and a parallax map between the first image and the second image may act as a first parallax map; the first parallax map is updated using the second parallax map, thereby achieving the effect of updating the parallax value between the first region of interest and the second region of interest recorded in the first parallax map with the parallax value between the first region of interest and the second region of interest recorded in the second parallax map. Therefore, the updated first parallax map can record more accurate parallax value between the first region of interest and the second region of interest. In the depth map corresponding to the binocular image generated on the basis of the updated first parallax map, more accurate depth values of the first region of interest and the second region of interest are recorded, to improve accuracy of depth estimate of the first region of interest and the second region of interest and enhance precision for depth estimate of the key regions in the binocular image.

### BRIEF DESCRIPTION OF THE DRAWINGS

Brief introduction of the drawings required in the description of the specific embodiments or the prior art are to be provided below to more clearly explain one or more embodiments of the present disclosure or the technical solutions in the prior art. It is obvious that the following drawings illustrate some embodiments of the present disclosure and those skilled in the art also may obtain other drawings on the basis of those illustrated ones without any exercises of inventive work.

FIG. 1 illustrates a schematic flowchart of the method for depth estimate of a binocular image provided by one embodiment of the present disclosure;

FIG. 2 illustrates a schematic diagram of principle of the parallax estimate model provided by one embodiment of the present disclosure;

FIG. 3 illustrates a structural diagram of an apparatus for depth estimate of the binocular image provided by one embodiment of the present disclosure;

FIG. 4 illustrates a structural diagram of the electronic device provided by one embodiment of the present disclosure.

### DETAILED DESCRIPTION OF EMBODIMENTS

To allow those skilled in the art to better understand the technical solutions in one or more embodiments of the present disclosure, the technical solutions in one or more embodiments of the present disclosure are to be described clearly and comprehensively below with reference to the drawings in one or more embodiments of the present disclosure. Apparently, the described embodiments are only part of the embodiments of the present disclosure, rather than all of them. Based on one or more embodiments of the present disclosure, all other embodiments obtained by those skilled in the art without requiring any exercises of inventive work should fall within the protection scope of the present disclosure.

To facilitate the understanding of various embodiments of the present disclosure, technical terms involved here are to be explained below.

Parallax value: for a binocular image captured by a binocular camera, a corresponding pixel of any one physical space point captured in each image of the binocular image is determined, i.e., two pixels are obtained; by the image-forming principle of the binocular camera, the two pixels have the same vertical coordinate value and different horizontal coordinate values. A difference between the two horizontal coordinate values is referred to as a parallax value of the pixel.

Parallax map: one image in the binocular image serves as the reference image; an image in which a pixel is in one-to-one correspondence with pixels in the reference image is generated; in case that a pixel value of each pixel in the generated image equals to a difference value between the horizontal coordinate value of a corresponding pixel in the reference image and the horizontal coordinate value of a respective pixel in a further image of the binocular image, the generated image is known as a parallax map between the binocular images produced from the perspective of the reference image. Accordingly, the parallax map is an image generated with one image in the binocular image as the reference image to record parallax values between the reference image and the further image of the binocular images. It is to be appreciated that pixel value of each pixel in the parallax map is the parallax value, and when the parallax value is calculated according to a given rule, e.g., the parallax value is equal to a horizontal coordinate value of a pixel in the reference image minus a horizontal coordinate value of a pixel in a further image, parallax values recorded in the generated parallax map also vary as different reference images are selected from the binocular image.

Depth map corresponding to the binocular image: after the parallax map between the binocular images is generated with one of the binocular images as the reference image, a depth map of the reference image can be generated based on the parallax map and parameters of a camera of the binocular camera for shooting the reference image; the depth image of the reference image is a corresponding depth image of the binocular image.

Region of interest: ROI. In machine vision and image processing fields, a region to be processed, as outlined by box, circle, ellipse, or irregular polygon in the image to be processed, is referred to as a region of interest, ROI. The region of interest is normally a region to be focused on during image processing.

In current schemes for estimating depth of the binocular image, the depth estimate for the key regions in the binocular image is less accurate. As such, embodiments of the present disclosure provide a method for depth estimate of a binocular image, which can improve the accuracy for depth estimate of key regions in the binocular image. The method may be applied to a dedicated server and executed by the server.

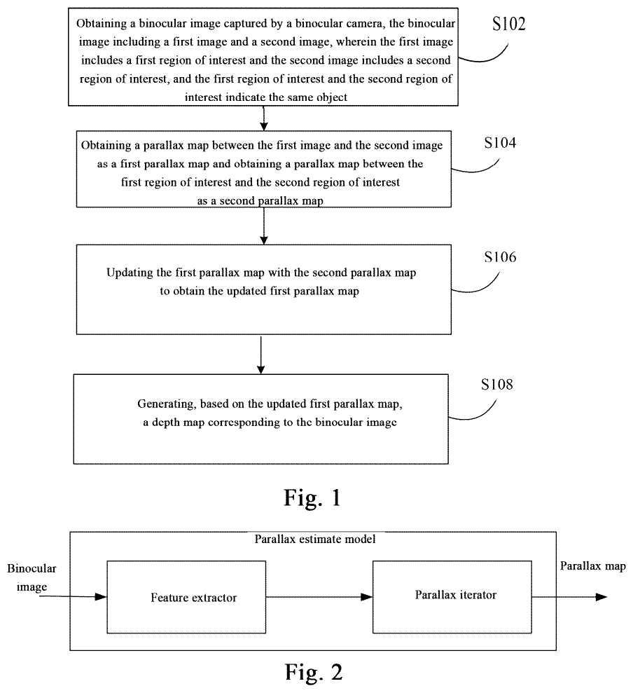

FIG. 1 is a schematic flowchart of the method for depth estimate of a binocular image provided by one embodiment of the present disclosure. As shown in FIG. 1, the method comprises:
Step S102: obtaining a binocular image captured by a binocular camera, the binocular image including a first image and a second image, wherein the first image includes a first region of interest and the second image includes a second region of interest, and the first region of interest and the second region of interest indicate the same object;
Step S104: obtaining a parallax map between the first image and the second image as a first parallax map and obtaining a parallax map between the first region of interest and the second region of interest as a second parallax map;
Step S106: updating the first parallax map with the second parallax map to obtain the updated first parallax map;
Step S108: generating, based on the updated first parallax map, a depth map corresponding to the binocular image.

In the embodiment of the present disclosure, a binocular image captured by a binocular camera is firstly obtained, the binocular image including a first image and a second image; the first image includes a first region of interest and the second image includes a second region of interest; and the first region of interest and the second region of interest indicate the same object. Then, a parallax map between the first image and the second image is obtained as a first parallax map and a parallax map between the first region of interest and the second region of interest is obtained as a second parallax map; and the first parallax map is updated with the second parallax map to obtain the updated first parallax map. In the end, a depth map corresponding to the binocular image is generated based on the updated first parallax map. Accordingly, by this embodiment, a parallax map between the first region of interest and the second region of interest may serve as a second parallax map; and a parallax map between the first image and the second image may act as a first parallax map; the first parallax map is updated using the second parallax map, thereby achieving the effect of updating the parallax value between the first region of interest and the second region of interest recorded in the first parallax map with the parallax value between the first region of interest and the second region of interest recorded in the second parallax map. Therefore, the updated first parallax map can record more accurate parallax value between the first region of interest and the second region of interest. In the depth map corresponding to the binocular image generated on the basis of the updated first parallax map, more accurate depth values of the first region of interest and the second region of interest are recorded, to improve accuracy of depth estimate of the first region of interest and the second region of interest and enhance precision for depth estimate of the key regions in the binocular image.

The method for depth estimate of the binocular image provided by the embodiment of the present disclosure can be applied to scenarios of real-time depth estimate and real-time modeling of the binocular image, to improve accuracy for real-time depth estimate of the key regions in the binocular image and precision for modeling of the key regions during real-time modeling process. For example, in a variety of scenarios including live broadcast of volumetric videos and live broadcast of virtual objects, on the basis of the binocular image captured by the binocular camera, the method for depth estimate of the binocular image in this embodiment can generate a depth map in real time, to perform real-time modeling in accordance with the depth map.

In the above step S102, the binocular image captured by the binocular camera is obtained. In this embodiment, the binocular camera may shoot any scenario to obtain the binocular image. For instance, the binocular camera may shoot people, landscapes and buildings etc. to obtain the binocular image. The binocular image includes a first image captured by a first camera of the binocular camera and a second image captured by a second camera of the binocular camera. In one example, the first camera is a left camera and the second camera is a right camera; and the first image is a left image and the second image is a right image. The first image includes a first region of interest and the second image includes a second region of interest. The first region of interest and the second region of interest indicate the same object. For example, the first region of interest and the second region of interest both indicate human faces. It is to be understood that the object indicated by the first region of interest and the second region of interest is the object to be focused on during depth estimate. It is required to enhance the accuracy for depth estimate of the object, so as to accurately model the object.

In one embodiment, the above method procedure also includes the following steps of:
determining the first region of interest in the first image and determining the second region of interest in the second image:
determining in the first image a first region where the object is located and determining in the second image a second region where the object is located;
offsetting, based on a parallax value between the first region and the second region, the first region in the first image, the offset first region being the first region of interest;
offsetting, based on the parallax value between the first region and the second region, the second region in the second image, the offset second region being the second region of interest.

In this embodiment, since the first image and the second image are the binocular image captured by the binocular camera, the image contents of the first image and the second image are basically the same. Therefore, the above object is present in both the first image and the second image. On this basis, the first region where the above object is located is determined in the first image and the second region where the above object is located is determined in the second image.

In one embodiment, the first image and the second image are rectified by epipolar lines. After the epipolar rectification, two pixels corresponding to the same point in the captured physical space in the first image and the second image are on the same level. First of all, a rectangular region where the above object is located is determined in the first image, and a rectangular region where the above object is located is determined in the second image. Considering that the two rectangular regions may have different widths and heights, they are also expanded to have the same width and height. The expanded rectangular region in the first image is the first region and the expanded rectangular region in the second image is the second region. It is seen that the first region and the second region have the same width and height.

Next, a parallax value between the first region and the second region is determined. In other words, a difference value between the horizontal coordinate of the pixel in the first region and the horizontal coordinate of the corresponding pixel in the second region is considered as the parallax value. According to the parallax value, the first region is offset in the first image and the offset first region is the first region of interest. According to the parallax value, the second region is offset in the second image and the offset second region is the second region of interest.

Accordingly, by this embodiment, the first region where the above object is located is determined in the first image and the second region where the above object is located is determined in the second image; and the first region and the second region are offset respectively based on the parallax value between the first region and the second region, to obtain the first region of interest and the second region of interest. Since the parallax value between the first region and the second region is taken into account during determination of the first region of interest and the second region of interest, the accuracy for determining the first region of interest and the second region of interest is improved and the precision for subsequently generating the second parallax map is also enhanced.

In one embodiment, to determine the parallax value between the first region and the second region, the above method procedure also includes the following step of:
obtaining a parallax value between a center pixel of the first region and a center pixel of the second region as the parallax value between the first region and the second region.

In this embodiment, a horizontal coordinate value of a center pixel of the first region is determined in the first region of the first image as a first horizontal coordinate value, and a horizontal coordinate value of a center pixel of the second region is determined in the second region of the second image as a second horizontal coordinate value. With the first image being reference, the second horizontal coordinate value is subtracted from the first horizontal coordinate value, to obtain a parallax value between the center pixel of the first region and the center pixel of the second region. The parallax value is viewed as the parallax value between the first region and the second region. The above procedure may be denoted by the following Formula (1):

$${disp}_{approx} = {center}_{1} - {center}_{2} \qquad ( Formula 1 )$$

In the Formula (1), dispₐₚₚᵣₒₓ represents the parallax value between the first region and the second region; center₁ indicates the horizontal coordinate value of the center pixel of the first region; and center₂ denotes the horizontal coordinate value of the center pixel of the second region.

As such, by this embodiment, the center pixel of the first region and the center pixel of the second region can serve as the representatives of the first region and the second region, to obtain the parallax value between the center pixel of the first region and the center pixel of the second region as the parallax value between the first region and the second region, thereby efficiently determining the parallax value between the first region and the second region.

In one embodiment, the above offsetting, based on the parallax value between the first region and the second region, the first region in the first image includes:
determining, based on the parallax value between the first region and the second region, and width and offset coefficients of the first region in the first image, an offset of the first region;
offsetting the first region in the first image in accordance with the offset of the first region.

In this embodiment, an offset of the first region is first determined based on the parallax value between the first region and the second region, and width and offset coefficients of the first region in the first image. This procedure may be denoted by the following Formula (2).

$$o f f {set}_{org 1} = {disp}_{approx} - {width}_{{BBox}_{init 1}} * A \qquad Formula ( 2 )$$

In the Formula (2), offset_{org1} represents the offset of the first region; dispₐₚₚᵣₒₓ indicates the parallax value between the first region and the second region; width_{BBox}_{ᵢₙᵢₜ₁} denotes the width of the first region in the first image; and A is an offset coefficient.

In one example,

$$A = \frac{{disp}_{dataset}}{{width}_{infer}} ,$$

where width_{infer} is a desired input width of the input image during parallax estimate by a parallax estimate model to be introduced later; it is required to transform the image for parallax estimate into desired input width to undertake the parallax estimate by the parallax estimate model. disp_{dataset} indicates an average parallax value of a set of training samples used by the parallax estimate module in the course of training; the set of training samples includes a plurality of binocular sample images and a parallax map of each binocular sample image, each binocular sample image consisting of two sample images.

In one example,

$${disp}_{dataset} = \frac{1}{N} {\sum }_{i = 1}^{N} {disp}_{i} ,$$

wherein i represents the i-th binocular sample image in the set of training samples used by the parallax estimate module in the course of training; dispᵢ denotes an average value of the parallax values of respective pixels in the i-th binocular sample image; and N indicates the number of binocular sample images included in the set of training samples. For the i-th binocular sample image, one image in the i-th binocular sample image serves as the reference image; a parallax value of each pixel in the reference image relative to a corresponding pixel in a further sample image in the i-th binocular sample image is calculated, and an average value of the parallax values of respective pixels in the reference image is obtained; dispᵢ is substituted by the average value into the above formula to calculate disp_{dataset}.

Next, the first region is offset in the first image in accordance with the offset of the first region. The offset of the first region is an offset of the first region in a horizontal direction. Accordingly, when the first region is offset in the horizontal direction in the first image in accordance with the offset of the first region, e.g., the horizontal coordinates of four vertices of the first region are offset in accordance with the offset of the first region, the offset first region is the first region of interest.

Thus, by this embodiment, an offset of the first region can be determined based on the parallax value between the first region and the second region, and width and offset coefficients of the first region in the first image; and the first region is offset in the first image in accordance with the offset of the first region, so as to accurately obtain the first region of interest in the first image.

In one embodiment, the above offsetting, based on the parallax value between the first region and the second region, the second region in the second image includes:
determining, based on the parallax value between the first region and the second region, and width and offset coefficients of the second region in the second image, an offset of the second region;
offsetting the second region in the second image in accordance with the offset of the second region.

In this embodiment, the second region is offset in the same manner as the first region. First of all, an offset of the second region is first determined based on the parallax value between the first region and the second region, and width and offset coefficients of the second region in the second image. The procedure may be denoted by the following Formula (3).

$$o f f {set}_{org 2} = {disp}_{approx} - {width}_{{BBox}_{init 2}} * A \qquad Formula ( 3 )$$

In Formula (3), offset_{org2} represents the offset of the second region; dispₐₚₚᵣₒₓ indicates the parallax value between the first region and the second region; width_{BBox}_{ᵢₙᵢₜ₂} denotes the width of the second region in the second image; and A is the offset coefficient.

In one example,

$$A = \frac{{disp}_{dataset}}{{width}_{infer}} ,$$

where width_{infer} is a desired input width of the input image during parallax estimate by a parallax estimate model to be introduced later; it is required to transform the image for parallax estimate into desired input width to undertake the parallax estimate by the parallax estimate model. disp_{dataset} indicates an average parallax value of a set of training samples used by the parallax estimate module in the course of training; the set of training samples includes a plurality of binocular sample images and a parallax map of each binocular sample image, each binocular sample image consisting of two sample images.

In one example,

$${disp}_{dataset} = \frac{1}{N} {\sum }_{i = 1}^{N} {disp}_{i} ,$$

wherein i represents the i-th binocular sample image in the set of training samples used by the parallax estimate module in the course of training; dispᵢ denotes an average value of the parallax values of respective pixels in the i-th binocular sample image; and N indicates the number of binocular sample images included in the set of training samples. For the i-th binocular sample image, one image in the i-th binocular sample image serves as the reference image; a parallax value of each pixel in the reference image relative to a corresponding pixel in a further sample image in the i-th binocular sample image is calculated, and an average value of the parallax values of respective pixels in the reference image is obtained; dispᵢ is substituted by the average value into the above formula to calculate disp_{dataset}.

As can be seen, since the width of the second region in the second image is identical to the width of the first region in the first image, and the Formula (2) and the Formula (3) have the same offset coefficient, the value of the offset of the second region calculated based on the Formula (3) is equal to the value of the offset of the first region calculated by the Formula (2).

Next, the second region is offset in the second image in accordance with the offset of the second region. The offset of the second region is an offset of the second region in a horizontal direction. Accordingly, when the second region is offset in the horizontal direction in the second image in accordance with the offset of the second region, e.g., the horizontal coordinates of four vertices of the second region are offset in accordance with the offset of the second region, the offset second region is the second region of interest.

Therefore, by this embodiment, an offset of the second region can be determined based on the parallax value between the first region and the second region, and width and offset coefficients of the second region in the second image; the second region is offset in the second image in accordance with the offset of the second region, so as to accurately obtain the second region of interest in the second image.

In the above step 104, a parallax map between the first image and the second image is obtained as a first parallax map and a parallax map between the first region of interest and the second region of interest is obtained as a second parallax map.

In one embodiment, obtaining the parallax map between the first image and the second image as the first parallax map includes:
generating, via a parallax estimate model, the parallax map between the first image and the second image as the first parallax map, wherein the parallax estimate model is obtained from training with binocular video frames sequentially arranged in time order.

In this embodiment, a parallax estimate model is pre-trained. FIG. 2 illustrates a schematic diagram of principle of the parallax estimate model provided by one embodiment of the present disclosure. As shown in FIG. 2, the parallax estimate model includes a feature extractor and a parallax iterator. The feature extractor may be a 2D fully convolutional network (FCN) and its variants; and the parallax iterator may be a Gated Recurrent Unit (GRU) and its variants. In this embodiment, the first image and the second image may be input to the parallax estimate model; and the feature extractor in the parallax estimate model may extract an image feature of the first image to obtain the first image feature and also may extract an image feature of the second image to obtain the second image feature.

The parallax estimate model may analyze cross-correlation between the first image feature and the second image feature, to obtain a feature cross-correlation matrix between the first image feature and the second image feature. In the matrix, a feature similarity between each of the first image feature and each of the second image feature is recoded via multiple matrix values.

Then, the parallax estimate model may randomly generate an initial parallax map for the first image and the second image and input the initial parallax map and the above feature cross-correlation matrix into the parallax iterator. The parallax iterator may adjust parallax values in the initial parallax map in accordance with the above feature cross-correlation matrix. The adjusted initial parallax map is upsampled to be the first parallax map.

In view of the aforementioned introduction, the parallax estimate model has a desired input width for the input image, and it is required to transform the width of the first image and the second image into the desired input width to undertake the parallax estimate by the parallax estimate model.

When the method in the embodiment of the present disclosure is applied to generate volumetric videos in real time, the parallax estimate model may obtain a plurality of binocular images continuously shot by the binocular camera, where each binocular image includes a first image and a second image, and the respective binocular image is a video frame sequence resulted from continuous shooting in time sequence. On this basis, the respective binocular image is input to the parallax estimate model for parallax estimate, and the parallax estimate model may take the parallax map resulted from estimate of the previous binocular image (in time sequence) as the initial parallax map for the next binocular image, so as to improve the efficiency for estimating the parallax map of the next binocular image based on the initial parallax map. Besides, the parallax iterator can obtain the parallax map of the next binocular image through fewer iterations.

When the method in the embodiment of the present disclosure is applied to generate volumetric videos in real time, the feature extractor and the parallax iterator in the parallax estimate model may be accelerated via TensorRT (Nvidia inference engine acceleration tool). The above generation of the feature cross-correlation matrix and the upsampling of the adjusted initial parallax map may be accelerated using CUDA (Compute Unified Device Architecture), to increase the parallax estimate speed and the modeling rate in the scenarios of generating volumetric videos in real time and satisfy the requirement of modeling on real-time performance.

A brief introduction of the procedure of training the parallax estimate model is provided below. The training of the parallax estimate model indicates training of parameters in the feature extractor and the parallax iterator. In view of the above introduction, the parallax estimate model is resulted from training the set of training samples, where the set of training samples includes a plurality of binocular sample images and the parallax map of each binocular sample image, each binocular sample image consisting of two sample images. For each binocular sample image, one image therein serves as the reference image; a parallax value of each pixel in the reference image relative to a corresponding pixel in a further sample image in the binocular sample image is calculated, and the parallax map of the binocular sample image is generated according to the calculated parallax value. In the course of training, the parallax training model is trained in accordance with a plurality of binocular sample images and the parallax map of each binocular sample image.

In this embodiment, the parallax estimate model is resulted from training with binocular video frames sequentially arranged in time order. As an example, every time the parallax estimate model is trained, a plurality of binocular sample images continuously shot by the binocular camera is selected from the set of training samples; the plurality of binocular sample images is a plurality of binocular video frames sequentially arranged in time order. For example, the third to fifteenth binocular video frames continuously shot are selected. The parallax estimate model is trained according to the selected binocular video frames, such that the parallax map obtained from estimate by the parallax estimate model has a relatively high stability in time domain. As a result, the parallax estimate model, when estimating the parallax map of the continuously shot binocular video frames, can ensure that the parallax value of the same point in the physical space changes continuously and stably in the respective binocular video frame. In addition, the parameter of the parallax estimate model after each training may serve as the initial parameter of the model for next training and the loss returns. Moreover, a random Gaussian noise is increased in each binocular sample image of the set of training samples to enhance model stability.

Accordingly, by this embodiment, a parallax map between the first image and the second image can be generated via a parallax estimate model as a first parallax map. Since the parallax estimate model is obtained from training with binocular video frames sequentially arranged in time order, the parallax map resulted from the estimate by the parallax estimate model has a relatively high stability in time domain. When the parallax estimate model estimates the parallax map of the continuously captured binocular video frames, it is ensured that the parallax value of the same point in the physical space changes continuously and stably in the respective binocular video frame.

In one embodiment, obtaining the parallax map between the first region of interest and the second region of interest as the second parallax map includes:
cropping the first region of interest in the first image to obtain a first region image and cropping the second region of interest in the second image to obtain a second region image;
generating, via the parallax estimate model, a parallax map between the first region image and the second region image as a second parallax map, wherein the parallax estimate model is obtained from training with binocular video frames sequentially arranged in time order.

In this embodiment, the first region of interest in the first image is first cropped to obtain a first region image and the second region of interest in the second image is cropped to obtain a second region image. Next, the width of the first region image and the second region image are transformed into a desired input width of the parallax estimate model. The transformed first region image and the transformed second region image are then input to the parallax estimate model for parallax estimate, thereby obtaining the second parallax map. The parallax estimate procedure and the introduction of the parallax estimate model may refer to the previous description and will not be covered here.

Accordingly, by this embodiment, the second parallax map can be generated via the parallax estimate model; since the parallax estimate model is obtained from training with binocular video frames sequentially arranged in time order, the parallax map resulted from the estimate by the parallax estimate model has a relatively high stability in time domain. When the parallax estimate model estimates the parallax map of the binocular video frames continuously captured, it is ensured that the parallax value of the same point in the physical space changes continuously and stably in the respective binocular video frame.

In one embodiment, a size of the first parallax map is an output size of the parallax estimate model, and generating, via the parallax estimate model, the parallax map between the first region image and the second region image as the second parallax map includes:
processing, via the parallax estimate mode, the first region image and the second region image to obtain an output image, wherein a size of the output image is the output size;
transforming the size of the output image in accordance with a size of the first region of interest in the first image, the output size, and size and transformation coefficients of the first image after transforming the first image into the output size, to obtain the second parallax map, wherein a size of the second parallax map is identical to a size of the first region of interest in the first parallax map.

From the above description, the parallax estimate model has a desired input width for the input image and it is required to transform the width of the image into the desired input width to undertake the parallax estimate by the parallax estimate model. Correspondingly, the parallax estimate model also has an output size including output width and output height, where the output width equals to the desired input width of the input image proposed by the parallax estimate model and the output height is equal to the desired input height of the input image provided by the parallax estimate model. Hence, the width and height of the first parallax map output by the parallax estimate model are equal to the output width and height of the parallax estimate model.

On this basis, when a parallax map between the first region image and the second region image is generated via the parallax estimate model as a second parallax map, the first region image and the second region image are first processed to obtain an output image. The output image represents the parallax value between the first region image and the second region image, and the height and the width of the output image are equal to the output height and width of the parallax estimate mode. In this embodiment, the first parallax map is an image generated with the first image as the reference. As such, the size of the output image is transformed in accordance with size of the first region of interest in the first image, the output size of the parallax estimate mode, and size and transformation coefficient of the first image after transforming the size of the first image into the output size of the parallax estimate mode, to obtain the second parallax map. This procedure may be carried out external to the parallax estimate model. In one example, the size of the output image is transformed in accordance with width of the first region of interest in the first image, the output width of the parallax estimate mode, and width and transformation coefficient of the first image after transforming the width of the first image into the output width of the parallax estimate mode, to obtain the second parallax map. The width and the height of the second parallax map are identical to the width and the height of the first region of interest in the first parallax map. Besides, the second parallax map is an image generated with the first region of interest as the reference.

The output image is transformed to obtain the second parallax map, such that the size of the second parallax map is identical to the size of the first region of interest in the first parallax map. This can enhance the accuracy for subsequently updating the first parallax map using the second parallax map and generate a more accurate updated first parallax map.

In one embodiment, by the Formula (4) and Formula (5) below, the size of the output image is transformed in accordance with size of the first region of interest in the first image, the above output size, and size and transformation coefficient of the first image after transforming the first image into the output size, to obtain the second parallax map.

$${disp}_{org}^{crop} = {disp}_{infer}^{crop} * \frac{{width}_{{BBox}_{infer}}}{{width}_{infer}} + o f f {set}_{org} \qquad Formula ( 4 )$$

$${disp}_{org}^{crop} = {disp}_{infer}^{crop} * \frac{{width}_{{BBox}_{infer}}}{{width}_{infer}} \qquad Formula ( 5 )$$

In the Formulae (4) and (5), offset_{org} indicates the transformation coefficient, which transformation coefficient is the offset of the first region or the second region as stated above. According to the previous disclosure, the offsets of the first region and the second region are the same, so the offset here is denoted by the same symbol. width_{BBox}_{_{infer}} represents the width of the first region of interest in the first image after transforming the width of the first image into the output width of the parallax estimate model; width_{infer} indicates the output width of the parallax estimate model; width_{org} denotes the width of the first image; disp_{infer}^{crop} is the above output image; disp_{org}^{crop} represents the output image after transforming the width and the height into the width and the height of the first region of interest; and disp_{fuseback}^{crop} denotes the second parallax map.

The formulae (4) and (5) work as follows: pixel coordinates of each pixel in the above output image are sequentially introduced into the formulae (4) and (5) for calculation to obtain each calculated pixel coordinate; the second parallax map is generated according to pixel values of the calculated pixel coordinates. For the first type of pixels in the second parallax map, in case that pixel coordinates of the first type of pixels are calculated via the formulae (4) and (5) on the basis of the second type of pixels in the output image, the pixel values (i.e., parallax value) of the first type of pixels are equal to the pixel values of the second type of pixels in the output image. For the other pixels in the second parallax map except for the first type of pixels, pixel values (i.e., parallax value) of the other pixels may be sampled in the second parallax map.

An upsampling or downsampling operation is performed on each calculated pixel value to generate the second parallax map.

It is to be appreciated that if the first parallax map is an image generated with the second image as the reference, a procedure similar to the one described above may be performed, i.e., the size of the output image is transformed in accordance with width of the second region of interest in the second image, the output width of the parallax estimate mode, and width and transformation coefficient of the second image after transforming the width of the second image into the output width of the parallax estimate mode, to obtain the second parallax map. The width and the height of the second parallax map are identical to the width and the height of the second region of interest in the second parallax map. Besides, the second parallax map is an image generated with the second region of interest as the reference.

Accordingly, by this embodiment, the first region image and the second region image can be processed via the parallax estimate mode to obtain an output image; and the size of the output image is transformed in accordance with size of the first region of interest in the first image, the output size of the parallax estimate mode, and size and transformation coefficient of the first image after transforming the size of the first image into the output size of the parallax estimate mode, to obtain the second parallax map. Since the size of the second parallax map is identical to size of the first region of interest in the first parallax map, the accuracy for subsequently updating the first parallax map with the second parallax map is enhanced and the updated first parallax map can be generated more accurately.

After the first parallax map and the second parallax map are obtained, in one embodiment, updating the first parallax map with the second parallax map to obtain the updated first parallax map includes:
updating the parallax value between the first region of interest and the second region of interest recorded by the first parallax map with the parallax value between the first region of interest and the second region of interest recorded by the second parallax map, to obtain the updated first parallax map.

In this embodiment, the second parallax map is generated with the first region of interest as the reference, and records parallax values between each pixel in the first region of interest and corresponding pixel in the second region of interest. The first parallax map is an image generated with the first image as the reference, and records parallax values between each pixel in the first image and corresponding pixel in the second image. Thus, in this embodiment, the parallax values between the first region of interest and the second region of interest recorded by the first parallax map are updated using the parallax values between the first region of interest and the second region of interest recorded by the second parallax map, to obtain an updated first parallax map, which records more accurate parallax values between the first region of interest and the second region of interest. As a result, in the depth map corresponding to the binocular image, which is generated on the basis of the updated first parallax map, more accurate depth values of the first region of interest and the second region of interest are recorded, to improve the accuracy for depth estimate of the first region of interest and the second region of interest and enhance precision for depth estimate of key regions in the binocular image.

Hence, by this embodiment, the parallax values between the first region of interest and the second region of interest recorded by the first parallax map are updated using the parallax values between the first region of interest and the second region of interest recorded by the second parallax map, to obtain an updated first parallax map, which records more accurate parallax values between the first region of interest and the second region of interest. In this way, the accuracy for both parallax estimate and depth estimate of the key regions is improved.

In one embodiment, the first parallax map records a parallax value between a pixel in the first image and a pixel in the second image, the second parallax map records a parallax value between a pixel in the first region of interest and a pixel in the second region of interest, and correspondingly, updating the parallax value between the first region of interest and the second region of interest recorded by the first parallax map with the parallax value between the first region of interest and the second region of interest recorded by the second parallax map, to obtain the updated first parallax map includes:
identifying a pixel to be updated in the first image, wherein the pixel to be updated is located in the first region of interest and a difference value between a parallax value corresponding to the pixel to be updated recorded in the first parallax map and a parallax value corresponding to the pixel to be updated recorded in the second parallax map meets a parallax value requirement;
updating the parallax value corresponding to the pixel to be updated recorded in the first parallax map to the parallax value corresponding to the pixel to be updated recorded in the second parallax map, to obtain the updated first parallax map.

In this embodiment, the first parallax map is an image generated with the first image as the reference and records parallax values between each pixel in the first image and corresponding pixels in the second image. The second parallax map is an image generated with the first region of interest as the reference and records parallax values between each pixel in the first region of interest and corresponding pixels in the second region of interest. On this basis, pixels to be updated are identified in the first image in this embodiment. The pixels to be updated are located in the first region of interest. Besides, a difference value between a parallax value corresponding to the pixel recorded in the first parallax map and a parallax value corresponding to the pixel recorded in the second parallax map meets a parallax value requirement. Next, in the first parallax map, a parallax value corresponding to the pixel to be updated is updated to a parallax value corresponding to the pixel to be updated recorded in the second parallax map, to obtain the updated first parallax map.

In one embodiment, the above procedure of updating the first parallax map may be denoted by following Formula (6).

$$\{ \begin{matrix}{disp}_{fuseback}^{crop} , pixel ∈ crop and & \vert {disp}_{fuseback}^{crop} - {disp}_{infer}^{org} ( crop ) \vert < {threshold}_{dif f} \\ {disp}_{infer}^{org} , & otherwise\end{matrix} \qquad Formula ( 6 )$$

In the Formula (6), disp_{final} is the updated first parallax map; disp_{infer}^{org} indicates the first parallax map; disp_{fuseback}^{crop} represents the second parallax map; pixel∈crop indicates that the pixel is located in the first region of interest; disp_{infer}^{org} (crop) denotes parallax values between the first region of interest and the second region of interest recorded in the first parallax map; and threshold_{diff} is a preset parallax threshold.

As can be seen from the Formula (6), the pixel to be updated is located in the first region of interest, and an absolute value of a difference value between the parallax values corresponding to the pixels recorded in the first parallax map and parallax values corresponding to pixels recorded in the second parallax map is smaller than the pixel of the parallax threshold. For the pixel to be updated, its parallax value in the first parallax map is updated to the parallax value recorded in the second parallax map.

Accordingly, by this embodiment, the pixel to be updated can be identified by analyzing location of the pixel and parallax values of the pixel in the first parallax map and the second parallax map, and a parallax value corresponding to the pixel to be updated recorded in the first parallax map is updated to a parallax value corresponding to the pixel to be updated recorded in the second parallax map, to obtain the updated first parallax map.

In one embodiment, after the updated first parallax map is obtained, a depth map corresponding to the binocular image is also generated based on the updated first parallax map. For example, the updated first parallax map is an image generated with the first image as the reference and the updated first parallax map records parallax values between each pixel in the first image and corresponding pixels in the second image. The depth map of the first image is generated as the depth map corresponding to the binocular image in accordance with the updated first parallax map, the focal length of the camera for shooting the first image in the binocular camera and a distance between the two cameras in the binocular camera.

In one embodiment, generating, based on the updated first parallax map, the depth map corresponding to the binocular image includes:
removing defective parallax values from the updated first parallax map;
generating, based on the first parallax map with the defective parallax values removed, the depth map corresponding to the binocular image;
wherein the defective parallax values include one or more of: parallax value having a confidence level smaller than a confidence threshold, parallax value having a value not meeting a parallax value requirement, and parallax value having a value greater than a horizontal coordinate value of a pixel to which the parallax value belongs.

In this embodiment, in the updated first parallax map, defective parallax values are identified and deleted. That is, in the updated first parallax map, pixels with wrong pixel values are identified and deleted. Then, the depth map corresponding to the binocular image is generated based on the first parallax map with the defective parallax values removed. For example, the updated first parallax map is an image generated with the first image as the reference, and records parallax values between each pixel in the first image and corresponding pixels in the second image. Therefore, the depth map of the first image is generated as the depth map corresponding to the binocular image in accordance with the first parallax map with the defective parallax values removed, the focal length of the camera for shooting the first image in the binocular camera and a distance between the two cameras in the binocular camera.

In this embodiment, the defective parallax values include one or more of: a parallax value having a confidence level smaller than a confidence threshold, a parallax value having a value not meeting a parallax value requirement, and a parallax value having a value greater than a horizontal coordinate value of a pixel to which the parallax value belongs.

As an example, in case that the updated first parallax map is generated with the first image as the reference, the updated first parallax map, the first image and the projection map of the updated first parallax map may be input to a pre-trained confidence estimate model, through which a confidence level of a pixel value (i.e., parallax value) of each pixel in the updated first parallax map is determined, so as to determine the parallax value with a confidence level smaller than the confidence threshold in the updated first parallax map as defective parallax value, wherein the projection map is an image resulted from projection transformation of the first image in accordance with the first parallax map. For instance, if a given pixel in the first image has a horizontal coordinate of 5 and the parallax value of the pixel is recorded to be 3 in the parallax map, a projection pixel resulted from projection of the pixel in the projection map has a horizontal coordinate of 2 (i.e., 5−3=2).

As an example, a value requirement is preset for the parallax value. For example, a range is preconfigured for the parallax value. In accordance with the value requirement, the parallax value having a value not meeting the value requirement of the parallax value is determined as defective parallax value in the updated first parallax map.

As an example, each pixel in the updated first parallax map is in one-to-one correspondence with each pixel in the first image. If a given parallax value in the first parallax map is greater than a horizontal coordinate value of the pixel corresponding to the parallax value in the first mage, the parallax value is considered to have a value greater than the horizontal coordinate value of the pixel to which the parallax value belongs. In the updated first parallax map, the parallax value having a value greater than the horizontal coordinate value of the pixel to which the parallax value belongs is determined as the defective parallax value.

In one embodiment, the defective parallax value may be removed from the updated first parallax map by the following Formula (7).

$$\{ \begin{matrix}0 , {conf}_{net} < {threshold}_{net} or {disp}_{final} > & cid or {disp}_{final} < {threshold}_{disp} \\ {disp}_{final} , & otherwise\end{matrix} \qquad ( 7 )$$

In Formula (7), disp_{final}′ indicates the first parallax map with the defective parallax values removed; disp_{final} is the updated first parallax map; confₙₑₜ denotes confidence level of the parallax value; thresholdₙₑₜ is the preset confidence threshold; cid is the horizontal coordinate value of the pixel to which the parallax value belongs; and threshold_{disp} indicates the parallax threshold corresponding to the value requirement of the parallax value, wherein the parallax value threshold may be obtained by: determining the maximum depth value that may occur in the depth map corresponding to the binocular image; backward deducing the parallax value threshold on the basis of the maximum depth map; if the parallax value of the pixel is greater than the parallax value threshold, the depth value of the pixel is also larger than the maximum depth value, i.e., the depth value is irrational.

Thus, by this embodiment, defective parallax values can be removed from the updated first parallax map, and the depth map corresponding to the binocular image is generated based on the first parallax map with the defective parallax values removed, thereby increasing the accuracy for depth estimate of the binocular image.

In summary, there is provided a method for depth estimate of a binocular image, and the method embodiment at least achieves the following technical effects:
1. The first parallax map and the second parallax map can be rapidly and efficiently generated through the parallax estimate model, such that the depth estimate procedure satisfies the requirement for realtime performance and the estimated parallax map has a relatively high stability in time domain;
2. More accurate parallax values and depth values are obtained for the key regions, so as to improve the accuracy for depth estimate of the key regions.
3. The wrongly estimated parallax values may be removed to enhance the precision for depth estimate.

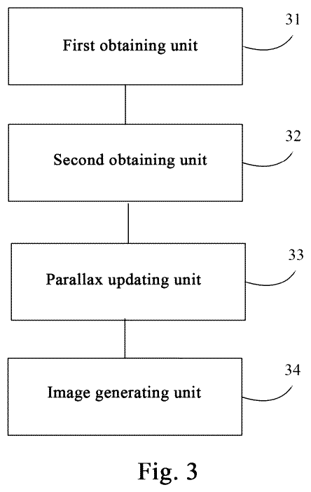

FIG. 3 is a structural diagram of an apparatus for depth estimate of the binocular image provided by one embodiment of the present disclosure. As shown in FIG. 3, the apparatus comprises:
a first obtaining unit 31 for obtaining a binocular image captured by a binocular camera, the binocular image including a first image and a second image, wherein the first image includes a first region of interest and the second image includes a second region of interest, and the first region of interest and the second region of interest indicate the same object;
a second obtaining unit 32 for obtaining a parallax map between the first image and the second image as a first parallax map and obtaining a parallax map between the first region of interest and the second region of interest as a second parallax map;
a parallax updating unit 33 for updating the first parallax map with the second parallax map to obtain the updated first parallax map;
an image generating unit 34 for generating, based on the updated first parallax map, a depth map corresponding to the binocular image.

Optionally, the apparatus also comprises a region determining unit for:
determining in the first image a first region where the object is located and determining in the second image a second region where the object is located;
offsetting, based on a parallax value between the first region and the second region, the first region in the first image, the offset first region being the first region of interest;
offsetting, based on the parallax value between the first region and the second region, the second region in the second image, the offset second region being the second region of interest.

Optionally, the region determining unit is specifically provided for:
obtaining a parallax value between a center pixel of the first region and a center pixel of the second region as the parallax value between the first region and the second region.

Optionally, the region determining unit is specifically provided for:
determining, based on the parallax value between the first region and the second region, and width and offset coefficients of the first region in the first image, an offset of the first region;
offsetting the first region in the first image in accordance with the offset of the first region.

Optionally, the region determining unit is specifically provided for:
determining, based on the parallax value between the first region and the second region, and width and offset coefficients of the second region in the second image, an offset of the second region;
offsetting the second region in the second image in accordance with the offset of the second region.

Optionally, the second obtaining unit 32 is specifically provided for:
generating, via a parallax estimate model, the parallax map between the first image and the second image as the first parallax map, wherein the parallax estimate model is obtained from training with binocular video frames sequentially arranged in time order.

Optionally, the second obtaining unit 32 is specifically provided for:
cropping the first region of interest in the first image to obtain a first region image and cropping the second region of interest in the second image to obtain a second region image;
generating, via the parallax estimate model, a parallax map between the first region image and the second region image as a second parallax map, wherein the parallax estimate model is obtained from training with binocular video frames sequentially arranged in time order.

Optionally, a size of the first parallax map is an output size of the parallax estimate model; and the second obtaining unit 32 is specifically provided for:
processing, via the parallax estimate mode, the first region image and the second region image to obtain an output image, wherein a size of the output image is the output size;
transforming the size of the output image in accordance with a size of the first region of interest in the first image, the output size, and size and transformation coefficients of the first image after transforming the first image into the output size, to obtain the second parallax map, wherein a size of the second parallax map is identical to a size of the first region of interest in the first parallax map.

Optionally, the parallax updating unit 33 is specifically provided for:
updating the parallax value between the first region of interest and the second region of interest recorded by the first parallax map with the parallax value between the first region of interest and the second region of interest recorded by the second parallax map, to obtain the updated first parallax map.

Optionally, the first parallax map records a parallax value between a pixel in the first image and a pixel in the second image; the second parallax map records a parallax value between a pixel in the first region of interest and a pixel in the second region of interest; and the parallax updating unit 33 is specifically provided for:
identifying a pixel to be updated in the first image, wherein the pixel to be updated is located in the first region of interest and a difference value between a parallax value corresponding to the pixel to be updated recorded in the first parallax map and a parallax value corresponding to the pixel to be updated recorded in the second parallax map meets a parallax value requirement;
updating the parallax value corresponding to the pixel to be updated recorded in the first parallax map to the parallax value corresponding to the pixel to be updated recorded in the second parallax map, to obtain the updated first parallax map.

Optionally, the image generating unit 34 is specifically used for:
removing defective parallax values from the updated first parallax map;
generating, based on the first parallax map with the defective parallax values removed, the depth map corresponding to the binocular image;
wherein the defective parallax values include one or more of: a parallax value having a confidence level smaller than a confidence threshold, a parallax value having a value not meeting parallax value requirement, and a parallax value having a value greater than a horizontal coordinate value of a pixel to which the parallax value belongs.

The apparatus for depth estimate of the binocular image in the embodiment of the present disclosure can implement the respective procedure of the above method embodiment for depth estimate of the binocular image and achieve the same effects and functions, and thus will not be covered here.

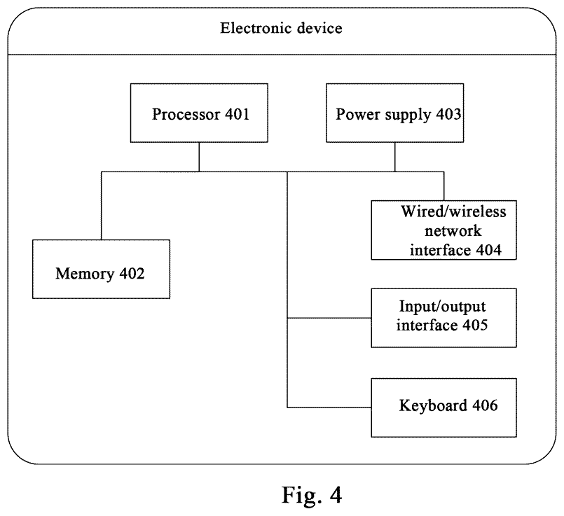

One embodiment of the present disclosure also provides an electronic device. FIG. 4 illustrates a structural diagram of the electronic device provided by one embodiment of the present disclosure. As shown in FIG. 4, the electronic device may greatly differ due to configuration or performance variations, and may include one or more processors 401 and a memory 402, which memory 402 may store one or more applications or data. The memory 402 may be provided for transient storage or persistent storage. The applications stored in the memory 402 may include one or more modules (not shown), and each module may include a series of computer-executable instructions in the electronic device. Moreover, the processor 401 may be configured to communicate with the memory 402, to execute a series of computer-executable instructions stored in the memory 402 on the electronic device. The electronic device also may include one or more Power supplys 403, one or more wired or wireless network interfaces 404, one or more input or output interfaces 405 and one or more keyboards 406 etc.

In a specific embodiment, the electronic device includes a processor; and a memory configured to store computer-executable instructions, wherein the computer-executable instructions, when executed, cause the processor to fulfill the following procedure of:
obtaining a binocular image captured by a binocular camera, the binocular image including a first image and a second image, wherein the first image includes a first region of interest and the second image includes a second region of interest, and the first region of interest and the second region of interest indicate the same object;
obtaining a parallax map between the first image and the second image as a first parallax map and obtaining a parallax map between the first region of interest and the second region of interest as a second parallax map;
updating the first parallax map with the second parallax map to obtain the updated first parallax map;
generating, based on the updated first parallax map, a depth map corresponding to the binocular image.

The electronic device in the embodiments of the present disclosure may implement the respective procedure of the above method embodiment for depth estimate of the binocular image and achieve the same effects and functions, and thus will not be covered here.

A further embodiment of the present disclosure also proposes a computer-readable storage medium for storing computer-executable instructions, wherein the computer-executable instructions, when executed, cause the processor to fulfill the following procedure of:
obtaining a binocular image captured by a binocular camera, the binocular image including a first image and a second image, wherein the first image includes a first region of interest and the second image includes a second region of interest, and the first region of interest and the second region of interest indicate the same object;
obtaining a parallax map between the first image and the second image as a first parallax map and obtaining a parallax map between the first region of interest and the second region of interest as a second parallax map;
updating the first parallax map with the second parallax map to obtain the updated first parallax map;
generating, based on the updated first parallax map, a depth map corresponding to the binocular image.

The storage medium in the embodiment of the present disclosure may implement the respective procedure of the above method embodiment for depth estimate of the binocular image and achieve the same effects and functions, and thus will not be covered here.

In various embodiments of the present disclosure, the computer-readable storage medium includes Read-Only Memory (ROM), Random Access Memory (RAM), magnetic disc or optical disc etc.

In the 1990s, improvement of a technology can be clearly distinguished between hardware improvement (for example, improvement on a circuit structure such as a diode, a transistor, or a switch) and software improvement (improvement on a method procedure). However, with the development of technologies, improvement of many method procedures can be considered as direct improvement of a hardware circuit structure. Almost every designer programs an improved method procedure to a hardware circuit, to obtain a corresponding hardware circuit structure. Therefore, it cannot be concluded that improvement of a method procedure should not be implemented by using a hardware entity module. For example, a Programmable Logic Device (PLD) (for example, Field Programmable Gate Array (FPGA)) is such an integrated circuit, the logical function of which is determined by device programming executed by a user. The designers program by themselves to “integrate” a digital system into a single PLD without requiring a chip manufacturer to design and produce a dedicated integrated circuit chip. In addition, instead of manually fabricating an integrated circuit chip, the programming is mostly implemented by “logic compiler” software, which is similar to a software compiler used during program and development. Original codes before compiling are also written in a specific programming language, which is referred to as Hardware Description Language (HDL), and there is more than one type of HDL, such as ABEL (Advanced Boolean Expression Language), AHDL (Altera Hardware Description Language), Confluence, CUPL (Cornell University Programming Language), HDCal, JHDL (Java Hardware Description Language), Lava, a Lola, MyHDL, PALASM, and RHDL (Ruby Hardware Description Language), etc. Currently, VHDL (Very-High-Speed Integrated Circuit Hardware Description Language) and Verilog are the most commonly used. Those skilled in the art should also understand that a hardware circuit that implements the logical method procedure can be easily obtained just by logically programming the method procedure with the above several hardware description languages and then into the integrated circuit.

A controller can be implemented in any appropriate ways. For example, the controller may take the form of a microprocessor or a processor, or a computer-readable medium that stores computer readable program codes (such as software or firmware) that can be executed by the (micro) processor, a logic gate, a switch, an Application-Specific Integrated Circuit (ASIC), a programmable logic controller, or an embedded microprocessor. Examples of the controller include, but are not limited to, the following microprocessors: ARC 625D, Atmel AT91SAM, Microchip PIC18F26K20, and Silicone Labs C8051F320. The memory controller can also be implemented as a part of the control logic of the memory. Those skilled in the art also know that it is completely feasible to logically program the method steps to enable the controller to achieve the same functions in the form of logic gate, switch, application-specific integrated circuit, programmable logic controller and embedded microcontroller etc., in addition to implementing the controller by pure computer readable program codes. Therefore, the controller can be considered as a hardware component, and the apparatus for implementing various functions included therein can also be considered as a structure in the hardware component. Alternatively, the apparatus for implementing various functions can be considered as both a software module for implementing the method and a structure in the hardware component.

The system, apparatus, module, or unit described in the above embodiments can be specifically implemented by a computer chip or an entity, or a product with a certain function. A typical implementation device is a computer. To be specific, the computer for example may be a personal computer, a laptop computer, a cellular phone, a camera phone, a smartphone, a personal digital assistant, a media player, a navigation device, an email device, a game console, a tablet computer, or a wearable device, or combinations thereof.

For ease of description, the apparatus is described by various units divided by functions. Certainly, during implementation of the present disclosure, the functions of the respective units can be implemented in one or more pieces of software and/or hardware.

Those skilled in the art should understand that one or more embodiments of the present disclosure can be provided as a method, a system, or a computer program product. Therefore, the one or more embodiments of the present disclosure may be in the form of embodiments of hardware only, embodiments of software only and embodiments of combination of software and hardware. In addition, the one or more embodiments of the present disclosure may take the form of a computer program product that is implemented on one or more computer-usable storage medium (including but not limited to a disk memory, a CD-ROM, and an optical memory) containing computer-usable program codes.

The present disclosure is described with reference to the flowcharts and/or block diagrams of the method, the device (system), and the computer program product according to the embodiments of the present disclosure. It should be understood that each process and/or block in the flowchart and/or the block diagram and a combination thereof can be implemented by the computer program instructions. These computer program instructions can be provided for a general-purpose computer, a dedicated computer, an embedded processor, or a processor of any other programmable data processing device to generate a machine, such that the instructions executed by a computer or a processor of other programmable data processing devices generate an apparatus for implementing the function specified in one or more flows in the flowcharts or in one or more blocks in the block diagrams.

These computer program instructions also can be stored in a computer readable memory that can instruct the computer or other programmable data processing device to work in a specific method, such that the instructions stored in the computer readable memory generate an article that includes an instruction apparatus. The instruction apparatus implements the function specified in one or more flows in the flowcharts or in one or more blocks in the block diagrams.

These computer program instructions also can be loaded to a computer or another programmable data processing device, such that a series of operation steps are performed on the computer or the other programmable device to generate computer-implemented processing. Therefore, the instructions executed on the computer or the other programmable device provide steps for implementing the function specified in one or more flows in the flowcharts or in one or more blocks in the block diagrams.

It is to be noted that the term “include”, “contain”, or any other variants thereof is intended to be a non-exclusive inclusion, such that a process, a method, a product, or a device including a list of elements not only includes those elements but also contains other elements which are not explicitly listed, or elements inherent to such process, method, product, or device. Elements defined by the expression of “including one . . . ” do not, without more constraints, exclude the presence of additional identical elements in the process, method, product, or device including the elements.

One or more embodiments of the present disclosure can be described in the general context of the computer executable instructions executed by the computer, e.g., program module. Generally, the program module includes a routine, a program, an object, an assembly, a data structure for executing a specific task or implementing a specific abstract data type. One or more embodiments of the present disclosure can also be carried out in distributed computing environments. In the distributed computing environments, tasks are performed by remote processing devices connected through a communications network. In the distributed computing environments, the program module can be located in both local and remote computer storage media including storage devices.

The embodiments in the present disclosure are all described in a progressive way. The same or similar parts among the embodiments may refer to each other. Each embodiment focuses on its difference from the others. Particularly, a system implementation is basically similar to a method implementation, and therefore is described briefly. Related parts of the system embodiment may refer to description of the method embodiment.

The previous description is merely embodiments of the present disclosure and does not restrict the present disclosure. For those skilled in the art, the present disclosure may be modified or changed in various ways. Any modifications, equivalent substitutions and improvements shall fall within the scope of the claims of the present disclosure as long as they are within the spirit and the principle of the present disclosure.

I/We claim:

1. A method for depth estimate of a binocular image, comprising:
obtaining a binocular image captured by a binocular camera, the binocular image including a first image and a second image, wherein the first image includes a first region of interest and the second image includes a second region of interest, and the first region of interest and the second region of interest indicate the same object;
obtaining a parallax map between the first image and the second image as a first parallax map and obtaining a parallax map between the first region of interest and the second region of interest as a second parallax map;
updating the first parallax map with the second parallax map to obtain the updated first parallax map; and
generating, based on the updated first parallax map, a depth map corresponding to the binocular image.

2. The method of claim 1, further comprising:
determining in the first image a first region where the object is located and determining in the second image a second region where the object is located;
offsetting, based on a parallax value between the first region and the second region, the first region in the first image, the offset first region being the first region of interest; and
offsetting, based on the parallax value between the first region and the second region, the second region in the second image, the offset second region being the second region of interest.

3. The method of claim 2, further comprising:
obtaining a parallax value between a center pixel of the first region and a center pixel of the second region as the parallax value between the first region and the second region.

4. The method of claim 2, wherein offsetting, based on the parallax value between the first region and the second region, the first region in the first image comprises:
determining, based on the parallax value between the first region and the second region, and width and offset coefficients of the first region in the first image, an offset of the first region; and
offsetting the first region in the first image in accordance with the offset of the first region.

5. The method of claim 2, wherein offsetting, based on the parallax value between the first region and the second region, the second region in the second image comprises:
determining, based on the parallax value between the first region and the second region, and width and offset coefficients of the second region in the second image, an offset of the second region; and
offsetting the second region in the second image in accordance with the offset of the second region.

6. The method of claim 1, wherein obtaining the parallax map between the first image and the second image as the first parallax map comprises:
generating, via a parallax estimate model, the parallax map between the first image and the second image as the first parallax map, wherein the parallax estimate model is obtained from training with binocular video frames sequentially arranged in time order.

7. The method of claim 6, wherein obtaining the parallax map between the first region of interest and the second region of interest as the second parallax map comprises:
cropping the first region of interest in the first image to obtain a first region image and cropping the second region of interest in the second image to obtain a second region image; and
generating, via the parallax estimate model, a parallax map between the first region image and the second region image as a second parallax map, wherein the parallax estimate model is obtained from training with the binocular video frames sequentially arranged in time order.

8. The method of claim 7, wherein a size of the first parallax map is an output size of the parallax estimate model, and generating, via the parallax estimate model, the parallax map between the first region image and the second region image as the second parallax map comprises:
processing, via the parallax estimate mode, the first region image and the second region image to obtain an output image, wherein a size of the output image is the output size; and
transforming the size of the output image in accordance with a size of the first region of interest in the first image, the output size, and size and transformation coefficients of the first image after transforming the first image into the output size, to obtain the second parallax map, wherein a size of the second parallax map is identical to a size of the first region of interest in the first parallax map.

9. The method of claim 1, wherein updating the first parallax map with the second parallax map to obtain the updated first parallax map comprises:
updating the parallax value between the first region of interest and the second region of interest recorded by the first parallax map with the parallax value between the first region of interest and the second region of interest recorded by the second parallax map, to obtain the updated first parallax map.

10. The method of claim 9, wherein the first parallax map records a parallax value between a pixel in the first image and a pixel in the second image, the second parallax map records a parallax value between a pixel in the first region of interest and a pixel in the second region of interest, and updating the parallax value between the first region of interest and the second region of interest recorded by the first parallax map with the parallax value between the first region of interest and the second region of interest recorded by the second parallax map, to obtain the updated first parallax map comprises:
identifying a pixel to be updated in the first image, wherein the pixel to be updated is located in the first region of interest and a difference value between a parallax value corresponding to the pixel to be updated recorded in the first parallax map and a parallax value corresponding to the pixel to be updated recorded in the second parallax map meets a parallax value requirement; and
updating the parallax value corresponding to the pixel to be updated recorded in the first parallax map to the parallax value corresponding to the pixel to be updated recorded in the second parallax map, to obtain the updated first parallax map.

11. The method of claim 1, wherein generating, based on the updated first parallax map, the depth map corresponding to the binocular image comprises:
removing defective parallax values from the updated first parallax map; and
generating, based on the first parallax map with the defective parallax values removed, the depth map corresponding to the binocular image;
wherein the defective parallax values include one or more of: a parallax value having a confidence level smaller than a confidence threshold, a parallax value having a value not meeting a parallax value requirement, and a parallax value having a value greater than a horizontal coordinate value of a pixel to which the parallax value belongs.

12. An apparatus for depth estimate of a binocular image, comprising:
a first obtaining unit for obtaining a binocular image captured by a binocular camera, the binocular image including a first image and a second image, wherein the first image includes a first region of interest and the second image includes a second region of interest, and the first region of interest and the second region of interest indicate the same object;
a second obtaining unit for obtaining a parallax map between the first image and the second image as a first parallax map and obtaining a parallax map between the first region of interest and the second region of interest as a second parallax map;
a parallax updating unit for updating the first parallax map with the second parallax map to obtain the updated first parallax map;
an image generating unit for generating, based on the updated first parallax map, a depth map corresponding to the binocular image.

13. An electronic device, comprising:
a processor; and
a memory configured to store computer-executable instructions, the computer-executable instructions, when executed, causing the processor to implement steps of a method for depth estimate of a binocular image comprising:
obtaining a binocular image captured by a binocular camera, the binocular image including a first image and a second image, wherein the first image includes a first region of interest and the second image includes a second region of interest, and the first region of interest and the second region of interest indicate the same object;
obtaining a parallax map between the first image and the second image as a first parallax map and obtaining a parallax map between the first region of interest and the second region of interest as a second parallax map;
updating the first parallax map with the second parallax map to obtain the updated first parallax map; and
generating, based on the updated first parallax map, a depth map corresponding to the binocular image.

14. The electronic device of claim 13, wherein the method further comprises:
determining in the first image a first region where the object is located and determining in the second image a second region where the object is located;
offsetting, based on a parallax value between the first region and the second region, the first region in the first image, the offset first region being the first region of interest; and
offsetting, based on the parallax value between the first region and the second region, the second region in the second image, the offset second region being the second region of interest.

15. The electronic device of claim 14, wherein the method further comprises:
obtaining a parallax value between a center pixel of the first region and a center pixel of the second region as the parallax value between the first region and the second region.

16. The electronic device of claim 14, wherein offsetting, based on the parallax value between the first region and the second region, the first region in the first image comprises:
determining, based on the parallax value between the first region and the second region, and width and offset coefficients of the first region in the first image, an offset of the first region; and
offsetting the first region in the first image in accordance with the offset of the first region.

17. The electronic device of claim 14, wherein offsetting, based on the parallax value between the first region and the second region, the second region in the second image comprises:
determining, based on the parallax value between the first region and the second region, and width and offset coefficients of the second region in the second image, an offset of the second region; and
offsetting the second region in the second image in accordance with the offset of the second region.

18. The electronic device of claim 13, wherein obtaining the parallax map between the first image and the second image as the first parallax map comprises:
generating, via a parallax estimate model, the parallax map between the first image and the second image as the first parallax map, wherein the parallax estimate model is obtained from training with binocular video frames sequentially arranged in time order.

19. The electronic device of claim 18, wherein obtaining the parallax map between the first region of interest and the second region of interest as the second parallax map comprises:
cropping the first region of interest in the first image to obtain a first region image and cropping the second region of interest in the second image to obtain a second region image; and
generating, via the parallax estimate model, a parallax map between the first region image and the second region image as a second parallax map, wherein the parallax estimate model is obtained from training with the binocular video frames sequentially arranged in time order.

20. The electronic device of claim 19, wherein a size of the first parallax map is an output size of the parallax estimate model, and generating, via the parallax estimate model, the parallax map between the first region image and the second region image as the second parallax map comprises:
processing, via the parallax estimate mode, the first region image and the second region image to obtain an output image, wherein a size of the output image is the output size; and
transforming the size of the output image in accordance with a size of the first region of interest in the first image, the output size, and size and transformation coefficients of the first image after transforming the first image into the output size, to obtain the second parallax map, wherein a size of the second parallax map is identical to a size of the first region of interest in the first parallax map.
